(19) United States
(12) Patent Application Publication
(10) Pub. No.: US 2006/0115319 A1
(43) Pub. Date: Jun. 1, 2006

(54) Slide joint featuring eccentric locking mechanism

(76) Inventor: Benjamin P. Reese, San Jose, CA (US)

Correspondence Address: RABIN & Berdo, PC, 1101 14TH STREET, NW, SUITE 500, WASHINGTON, DC, 20005, US

(21) Appl. No.: 10/999,927

(22) Filed: Dec. 1, 2004

(51) Int. Cl. F16B 7/10

(52) U.S. Cl. 403/80

(57) ABSTRACT

A slide joint that is fit over a first member and joints a second member to the first member includes a cylinder defining a bore having an axis and having a surface defining a groove and a ring including a flat body defining another bore having another axis and a sidewall extending from the body and fit over the cylinder with the bores partly overlapping each other to allow the first member to extend therethrough, the axes being eccentric with respect to each other. The ring is rotatable about the cylinder between a first position where the axes have a first eccentricity and a second position where the axes have a second eccentricity that is smaller than the first eccentricity whereby the bores tightly engage the first member to secure the slide joint on the first member.

### BACKGROUND OF THE INVENTION

1. Field of the Invention

The present invention relates to a slide joint that is movable along an elongate member, and in particular to a slide joint comprising an eccentric locking mechanism that selectively locks the slide joint at any position along the elongate member.

2. The Related Art

A slide joint is commonly employed to joint a first member to a second, elongate member of a collapsible or configuration-adjustable device, such as a foldable deck chair or an adjustable sun-shade device, whereby the first member is allowed to selectively move along the second member to realize collapse/expansion and adjustability of the device comprised of the joint. Some conventional designs only allow the slide joint to be moved between and secured at two opposite ends of the elongate member. This limits the applicability of the slide joint. Some other conventional designs employ complicated mechanisms to selectively secure the slide joint at predetermined locations along the elongate member, which suffers high costs and complicated and thus inconvenient operation.

Thus the present invention is aimed to provide a slide joint that overcomes the drawbacks of the prior art.

### SUMMARY OF THE INVENTION

A primary objective of the present invention is to provide a slide joint that is movable along an elongate member and is selectively secured at any position along the elongate member by a locking mechanism having a simple structure.

Another objective of the present invention is to provide a slide joint for moving along an elongate member, comprising a locking mechanism featuring a sliding cylinder and a rotating ring that are eccentric with respect to each other for selectively securing the slide joint on the elongate member by relative rotation therebetween.

A further objective of the present invention is to provide a slide joint that axially movably joint a first member to an elongate second member while allowing rotation of the first member with respect to the second member about an axis substantially normal to the second member.

The present invention will become more obvious from the following description when taken in connection with the accompanying drawings, which show, for purposes of illustration only, a preferred embodiment in accordance with the present invention.

### BRIEF DESCRIPTION OF THE DRAWINGS

FIG. 1 is a perspective view of a slide joint constructed in accordance with the present invention;

FIG. 2 is an exploded view of the slide joint of the present invention;

FIG. 3 is a perspective view showing the slide joint couples two members together;

FIG. 4 is a cross-sectional view taken along line 4-4 of FIG. 3;

FIG. 5 is a plan view showing the slide joint in a non-locked condition;

FIG. 6 is similar to FIG. 5 but showing the slide joint in a locked condition;

FIG. 7 is a perspective view showing a rocking chair in which a seat is coupled to a rocker by the slide joint of the present invention;

FIG. 8 is a perspective view showing a sun shade device comprising a canopy movably coupled to an upright stem by the slide joint of the present invention; and

FIG. 9 is an exploded view showing a slide joint constructed in accordance with another embodiment of the present invention.

### DETAILED DESCRIPTION OF THE PREFERRED EMBODIMENTS

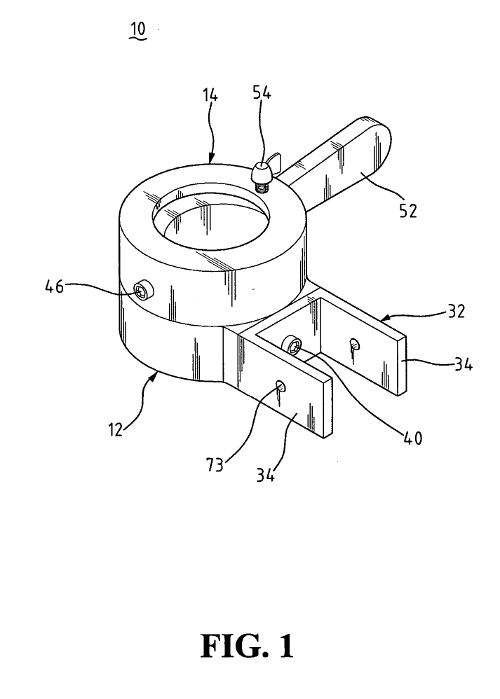

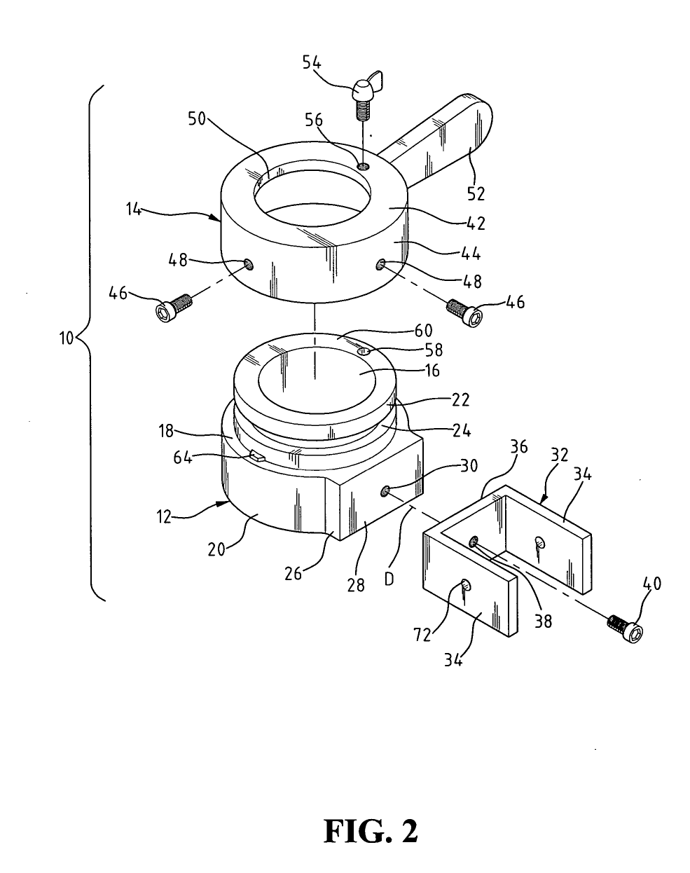

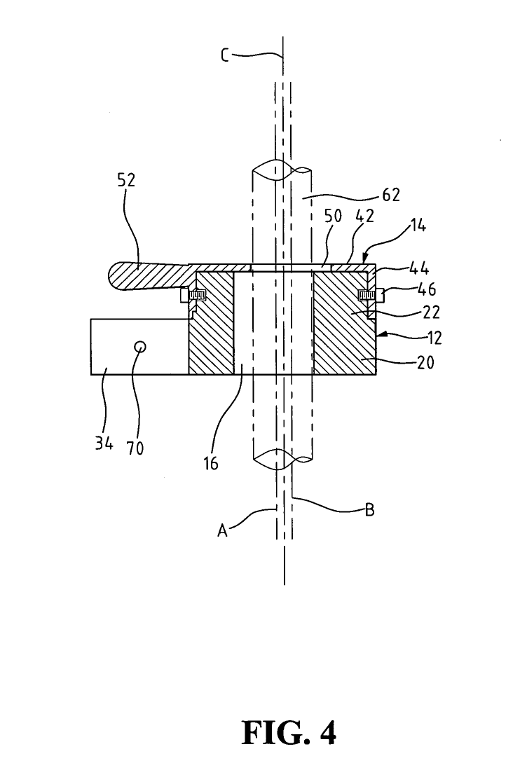

Referring to the drawings and in particular FIGS. 1 and 2, as well as FIG. 4, a slide joint constructed in accordance with the present invention, generally designated with reference numeral 10, comprises a cylinder 12 and a locking ring 14 rotatable with respect to each other. The cylinder 12 defines a central bore 16 extending along a first central axis A (see FIG. 4). The cylinder 12 has an outside surface (not labeled) forming a circumferential shoulder or flange 18, dividing the outside surface of the cylinder into a first, enlarged section 20 and a second, reduced section 22. A circumferential groove 24 is defined in the reduced section 22 and is axially spaced from the shoulder 18. The expanded section 20 forms a radial projection 26 forming a planar surface 28 in which an inner-threaded hole 30 is defined.

A U-shaped coupling member 32, comprising two spaced, opposite lugs 34 connected by a bottom 36. The bottom 36 is substantially flat and positioned against the planer surface 28 of the radial projection 26 in a surface contact manner. Preferably, the flat bottom 36 has a size and shape corresponding to the planer surface 28 of the radial projection 26 of the cylinder 12. A through hole 38 is defin in the flat bottom 36 for the extension of a pivot pin 40. The pivot pin 40 has an external thread (not labeled) that engages the inner-threaded hole 30 of the radial projection 26, while allowing rotation of the coupling member 32 about the pin 40 itself, thereby rotatably attaching the coupling member 32 to the cylinder 12.

Preferably, the inner-threaded hole 30 and the through holes 38, and thus the pivot pin 40 received therein, extend along an axis D that is substantially perpendicular to the central axis A of the cylinder 12. However, it is not necessary to be so. The axis D can be inclined with respect to the axis A at any desired angle.

The rotating ring 14 comprising a flat ring body 42 and a cylindrical side wall 44 extending from an outer circumference of the ring body 42 and rotatably fit over the reduced section 22 of the cylinder 12. The cylindrical side wall 44 of the ring 14 has an inner diameter that is substantially corresponding to an outside diameter of the reduced section 22 of the cylinder 12 whereby the cylindrical side wall 44 is snugly fit over the reduced section 22 and is guided, in rotation, by the reduced section 22 of the cylinder 12.

At least one inward projection is formed on an inside surface of the side wall 44 of the rotating ring 14 and movably received in the groove 24 of the cylinder 12 for guiding the rotation of the rotating ring 14 about the reduced section 22 of the cylinder 12. In the embodiment illustrated, the projection is comprised of a bolt 46 that threadingly engages an inner-threaded hole 48 defined through the side wall 44 with a tip of the bolt 46 extending through the side wall 44 and partially received in the groove 22. The receipt of the tip of the bolt 46 in the groove 24 functions to guide the rotation of the rotating ring 14 about the reduced section 22 and prevent the rotating ring 14 from sliding off the reduced section 22.

Preferably, three such guide projections 46 are provided on the side wall 44 and equally spaced along a circumference of the side wall 44.

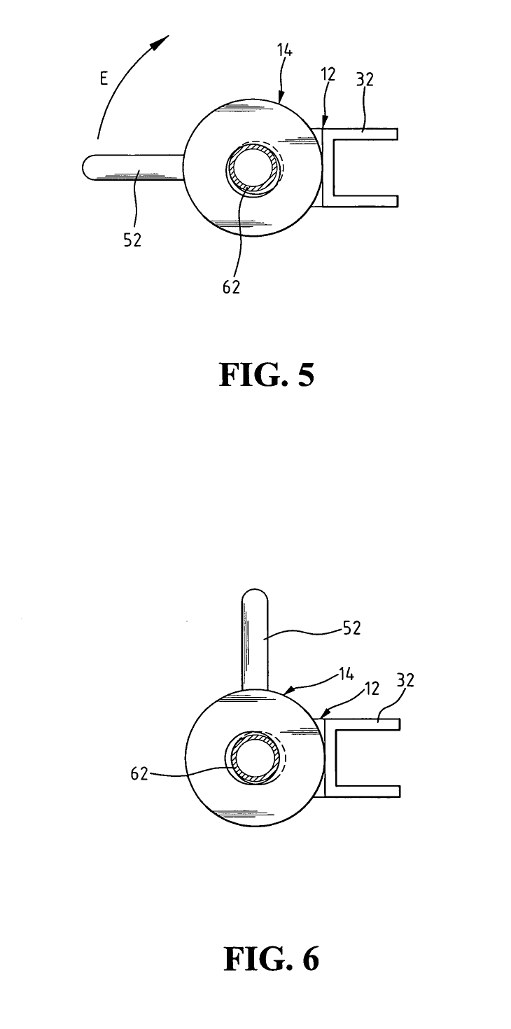

The ring body 42 forms a through hole or bore 50, preferably of the same size as the central bore 16 of the cylinder 12, defining a central axis B that is offset from the axis A, see FIG. 4. The rotation of the rotating ring 14 about the reduced section 22 of the cylinder 12 moves the through hole 50 between a locking position where the offset between the axes A and B is of a large amount (FIG. 6) and a non-locking position where the offset between the axes A and B is of a small amount (FIG. 5). A manual handle 52 projects from the side wall 44 of the rotating ring 14 in a radial direction to facilitate manual rotation of the rotating ring 14 about the reduced section 22 of the cylinder 12.

A bolt 54 engages an inner-threaded hole 56 defined in the ring body 42 and is of a size that allows a tip of the bolt 54 to extend beyond the ring body 42 and selectively engaging a dimple 58 defined in a top surface 60 of the reduced section 22 of the cylinder 12 to secure the rotating ring 14 in the locking condition. Preferably, the bolt 54 is a wing-headed bolt to facilitate manual rotation thereof.

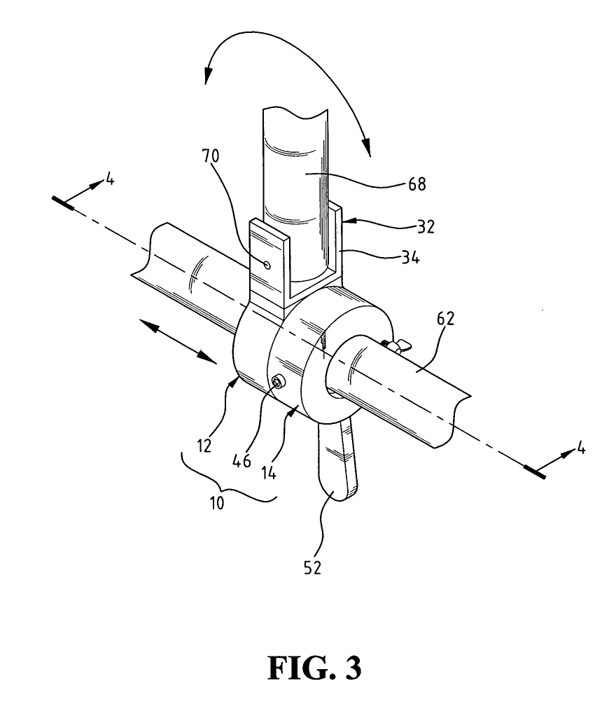

Also referring to FIGS. 3-6, to joint two members together, the slide joint 10 is fit over a first, elongate member 62 having a cross-sectional area smaller than the bore 16 of the cylinder 12 and the through hole 50 of the rotating ring 14. Thus, the first member 62 loosely extends through both the cylinder 12 and the ring 14. Preferably, the relative angular position between the ring 14 and the cylinder 12 is such that small friction is induced between the bore 16 of the cylinder 12 and the first member 62, and between the through hole 50 of the ring 14 and the first member 62, as illustrated in FIG. 5, which is the non-locking condition of the slide joint 10. This allows the slide joint 10 to be temporarily positioned along the first member 62.

By rotating the ring 14 with the aid of the manual handle 52 with respect to the cylinder 12 as indicated by arrow E of FIG. 5, the ring 14 is moved to the locking condition where the offset between the axes A and B of the through hole 50 and the bore 16 is largest, making the through hole 50 and the bore 16 tightly engaging the first member 62 thereby securing the slide joint 10 on the first member 62, as illustrated in FIG. 6. The bolt 54 may then be secured in the dimple 58 to fix the ring 14 with respect to the cylinder 12 and prevents the slide joint 10 from getting loosened.

Referring back to FIGS. 2 and 3, a block 44 is formed on the shoulder 18 of the cylinder 12 and is movably received in a slot 66 defined partially along an inner circumference of the side wall 44. The slot 66 has opposite ends that are brought into engagement with the block 44 when the ring 14 is rotated to the locking condition and non-locking condition, respectively. Thus, the block 64 serves as a stop that limits the rotation of the ring 14 in the directions toward both locking and non-locking conditions.

The lugs 34 of the coupling member 32 defines a space therebetween for receiving a second member 68 that is to be movably jointed to the first member 62 by the slide joint 10 of the present invention. The second member 68 can be fixed in the space between the lugs 34 by any known means, such as a pivot 70 (FIG. 3) extending through aligned holes 72 defined in the lugs 34 and a corresponding hole (not shown) defined through the second member 68. This allows the second member 68 to be rotatable with respect to the slide joint 10 about both the axis D and an axis defined by the pivot 70, which can be perpendicular to the axis D.

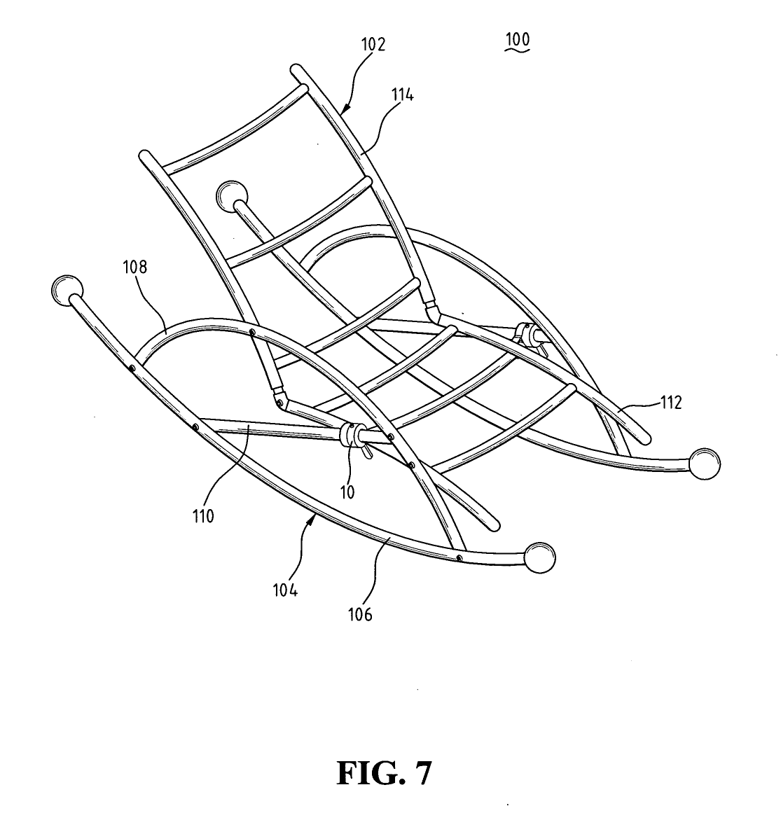

FIG. 7 shows a rocking chair, generally designated with reference numeral 100, comprises a seat portion 102 and two spaced rockers 104 on opposite sides of the seat portion 102. Each rocker 104 comprises a curved, concave bottom bar 106 and an arch-like, convex top bar 108. A stretch bar 110 extends between the top bar 108 and the bottom bar 106. A slide joint 10 of the present invention is fit over the stretch bar 110. In other words, the stretch bar 110 functions as the first member 62 discussed with reference to FIGS. 3 and 4.

The seat portion 102 comprises a seat base 112 and a backrest 114 pivotally jointed together. Opposite edges of the seat base 112 are attached to the coupling members 32 of the slide joints 10 and opposite edges of the backrest 114 are pivoted to the top bars 108 of the rockers 104. By sliding the slide joints 10 along the stretch bars 110, the backrest 114 is forced to move toward/away from the seat base 112 thereby adjusting the included angle between the backrest 114 and the seat base 112.

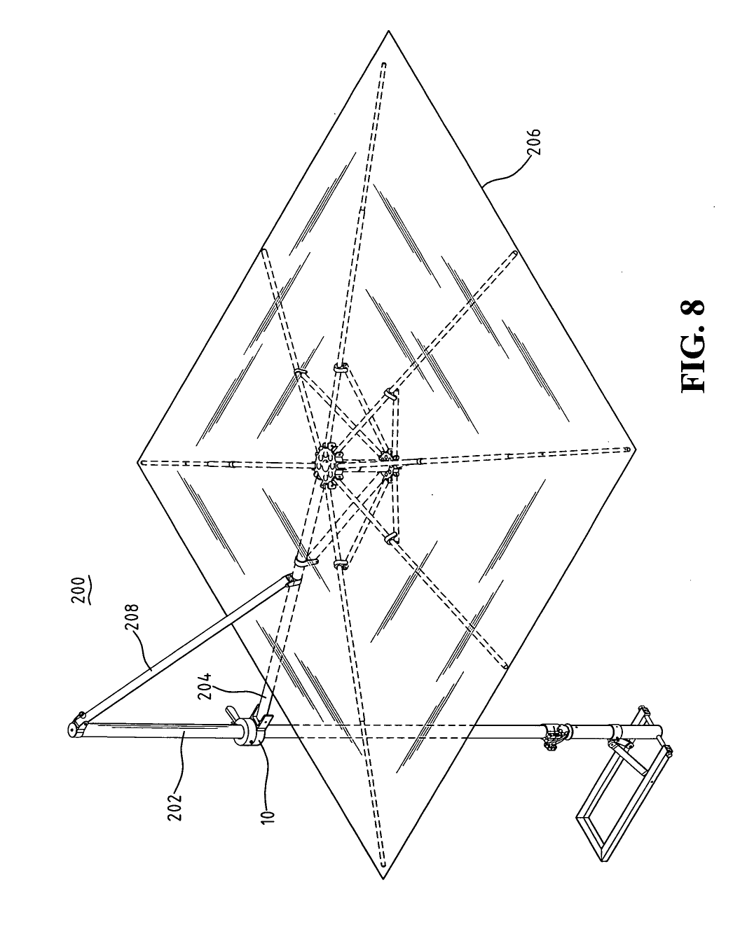

FIG. 8 shows another application of the slide joint of the present invention, wherein the slide joint 10 is slidably fit over an upright stem 202 of a sun shade device 200. The sun shade device 200 has a radially extending support arm 204 having a first end attached to the coupling member 32 of the slide joint 10 in a rotatable manner and an opposite second end supporting a canopy 206. A link 208 is arranged above the support arm 204 and has opposite ends respectively pivoted to the stem 202 and the support arm 204 for supporting the support arm 204 in an extended condition. By sliding the slide joint 10 along the stem 202, the support arm 204 and thus the canopy 206 can be moved toward/away from the stem 202 for shielding different area below the canopy 206.

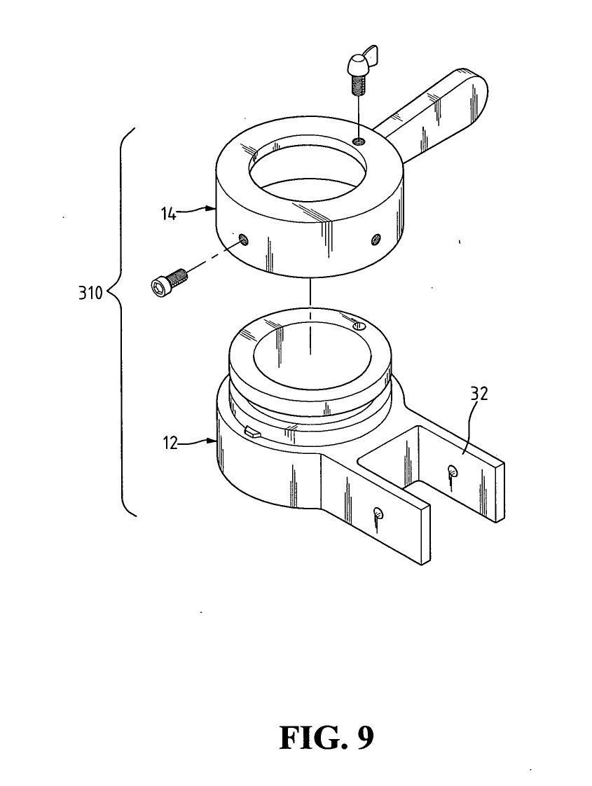

Also referring to FIG. 9, a slide joint constructed in accordance with another embodiment of the present invention, generally designated with reference numeral 310, is shown. The slide joint 310 is a modification of the slide joint 10 discussed with reference to FIGS. 1-6 and thus, the same reference numeral represent the same or similar parts, of which the description will be omitted for simplicity. The difference between the slide joint 310 and the slide joint 10 is that the coupling member 32 of the slide joint 10 is no longer rotatably attached to the cylinder 12. In other words, in the slide joint 310, the coupling member 32 is integrated with the cylinder 12. This reduces the degrees of freedom of a second member that is jointed to a first member along which the slide joint 310 is fit, but simplifies the overall construction of the slid joint 310 and thus reducing the costs. The remaining parts of the slide joint 310 are identical to those of the slide joint 10 and the previous description applies.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A slide joint adapted to be slidably fit over a first elongate member and coupled to a second member to thereby joint the second member to the first member in a movable manner, the slide joint comprising:
a cylinder defining a first bore having a first axis, the cylinder having an outside surface defining a circumferential groove; and
a rotating ring comprising a flat ring body defining a second bore having a second axis and a cylindrical side wall extending from the ring body and rotatably fit over the outside surface of the cylinder with the second bore partly overlapping the first bore to allow the first member to extend therethrough and the second axis being eccentric with respect to the first axis by an offset amount;
wherein the rotating ring is rotatable about the cylinder between a first position where the first and second axes have a first amount of offset and a second position where the first and second axes have a second amount of offset that is smaller than the first amount of offset whereby the first and second bores tightly engage the first member to secure the slide joint on the first member.

2. The slide joint as claimed in claim 1, wherein the cylinder comprises a coupling member adapted to connect the second member, the coupling member comprising a U-shape having opposite and spaced lugs adapted to receive and fix the second member therebetween.

3. The slide joint as claimed in claim 2, wherein the lugs define aligned holes receiving a pivot that pivotally attach the second member to the coupling member.

4. The slide joint as claimed in claim 2, wherein the coupling member is rotatably mounted to the cylinder.

5. The slide joint as claimed in claim 2, wherein the coupling member is integrated with the cylinder.

6. The slide joint as claimed in claim 1, wherein the cylinder defines a circumferential groove along the outside surface thereof and wherein the side wall of the rotating ring forms at least a projection on an inside surface thereof to be partially received in the groove.

7. The slide joint as claimed in claim 6, wherein the projection comprises a bolt engaging an inner-threaded hole defined through the side wall of the rotating ring with a tip of the bolt extending beyond the inside surface of the side wall and movably received in the groove.

8. The slide joint as claimed in claim 1, wherein the outside surface of the cylinder forms a circumferential flange to support the side wall of the rotating ring thereon.

9. The slide joint as claimed in claim 1, wherein the cylinder forms a stop block on the outside surface thereof and wherein the side wall of the rotating ring defines a slot in an inside surface thereof extending partly along an inner circumference thereof to movably receive the stop block therein, the slot having opposite ends engageable by the stop block at the first and second positions of the rotating ring, respectively.

10. The slide joint as claimed in claim 1, wherein the rotating ring comprises a radially extending handle that allows for manual rotation of the rotating ring about the cylinder.

11. The slide joint as claimed in claim 1, wherein the rotating ring defines an inner-threaded hole threadingly receiving a bolt and wherein the cylinder defines a corresponding dimple with which a tip of the bolt engages to secure the rotating ring in the second position.

12. A slide joint adapted to be slidably fit over a first elongate member and coupled to a second member to thereby joint the second member to the first member in a movable manner, the slide joint comprising:
a cylinder defining a first bore having a first axis, the cylinder having an outside surface forming a circumferential shoulder dividing the outside surface into an expanded section and a reduced section, a circumferential groove being defined in the reduced section, and a stop block formed on the shoulder; and
a rotating ring comprising a flat ring body defining a second bore having a second axis and a cylindrical side wall extending from the ring body and rotatably fit over the reduced section of the cylinder and resting on the shoulder with the second bore partly overlapping the first bore to allow the first member to extend therethrough and the second axis being eccentric with respect to the first axis by an offset amount, the side wall of the rotating ring forming at least a projection on an inside surface thereof to be partially received in the groove for preventing the rotating ring from sliding off the reduced section, the side wall of the rotating ring defining a slot in an inside surface thereof extending partly along an inner circumference thereof to receive the stop block therein;
wherein the rotating ring is rotatable about the cylinder between a first position where the first and second axes have a first amount of offset and a second position where the first and second axes have a second amount of offset that is smaller than the first amount of offset whereby the first and second bores tightly engage the first member to secure the slide joint on the first member, the slot of the rotating ring having opposite ends engageable by the stop block at the first and second positions of the rotating ring, respectively.

13. The slide joint as claimed in claim 12, wherein the cylinder comprises a coupling member adapted to connect the second member, the coupling member comprising a U-shape having opposite and spaced lugs adapted to receive and fix the second member therebetween.

14. The slide joint as claimed in claim 12, wherein the projection formed on the inside surface of the side wall of the rotating ring comprises a bolt engaging an inner-threaded hole defined through the side wall of the rotating ring with a tip of the bolt extending beyond the inside surface of the side wall and movably received in the groove.

15. The slide joint as claimed in claim 12, wherein the rotating ring comprises a radially extending handle that allows for manual rotation of the rotating ring about the reduced section of the cylinder.

16. The slide joint as claimed in claim 12, wherein the rotating ring defines an inner-threaded hole in the flat ring body thereof in which a bolt is threadingly received and wherein the reduced section of the cylinder has a top face in which a dimple is defined, a tip of the bolt being engageable with the dimple to secure the rotating ring in the second position.
